(19) United States
(12) Patent Application Publication
(10) Pub. No.: US 2012/0120004 A1
(43) Pub. Date: May 17, 2012

(54) TOUCH CONTROL DEVICE AND TOUCH CONTROL METHOD WITH MULTI-TOUCH FUNCTION

(76) Inventors: Yao-Tsung Chang, New Taipei City (TW); Chia-Hsien Li, New Taipei City (TW)

(21) Appl. No.: 13/154,459

(22) Filed: Jun. 7, 2011

(30) Foreign Application Priority Data
Nov. 11, 2010 (TW) 099138805

(51) Int. Cl. G06F 3/041

(52) U.S. Cl. 345/173; 178/18.03

(57) ABSTRACT

A touch control device includes a housing having a first side and a second side different from the first side. The touch control device further includes a first touch sensing unit installed on the first side of the housing for detecting a first touch event so as to generate a first sensing signal according to the first touch event, and a second touch sensing unit installed on the second side of the housing for detecting a second touch event so as to generate a second sensing signal according to the second touch event. The touch control device further includes a control unit coupled to the first touch sensing unit and the second touch sensing unit, for generating corresponding operation instruction according to the first sensing signal and the second sensing signal simultaneously.

### BACKGROUND OF THE INVENTION

1. Field of the Invention

The present invention relates to a touch control device and a touch control method with multi-touch function, and more particularly, to a touch control device with multi-touch function performed by touch sensing units disposed on different sides thereon and the related touch control method.

2. Description of the Prior Art

Currently, in the market of various kinds of consumer electronic products, touch panels have been widely applied in portable electronic devices, such as personal digital assistants (PDA), mobile phones, and PDA phones for serving as the interface of information communication tool between the users. Since modern electronic products increasingly become smaller, thinner, and lighter, the display device with a touch panel has gradually become the key component of various electronic products in order to save space and to replace traditional input apparatuses, such as a keyboard, and a mouse, leaning on the trend of human-based designed tablet computers. There are many kinds of touch panels with different technology, such as a capacitive touch panel, a resistance touch panel, an ultrasonic touch panel, or infrared touch panel, for utilizing in many different fields. Most touch control electronic products is only equipped with single-touch function. That is, the touch panel with touch-input and display function is disposed on a single side of the electronic product. However, such kind of touch control technology can no longer meet the requirement of the current electronic products. For example, if a multi-touch technology by utilizing gesture or plural fingers simultaneously to execute an instruction is applied on a single touch panel, it can no longer meet the requirement of ergonomics and various user interfaces.

### SUMMARY OF THE INVENTION

The present invention provides a touch control device with multi-touch function performed by touch sensing units disposed on different sides thereon and the related touch control method for solving above drawbacks.

According to the claimed invention, a touch control device with multi-touch function includes a housing including a first side and a second side different from the first side, a first touch sensing unit installed on the first side of the housing for detecting a first touch event so as to generate a first sensing signal according to the first touch event, a second touch sensing unit installed on the second side of the housing for detecting a second touch event so as to generate a second sensing signal according to the second touch event, and a control unit coupled to the first touch sensing unit and the second touch sensing unit, for generating a corresponding operation instruction to control a display object according to the first sensing signal and the second sensing signal simultaneously.

According to the claimed invention, a touch control method for multi-touch function includes a first touch sensing unit installed on a first side of a housing detecting a first touch event so as to generate a first sensing signal, a second touch sensing unit installed on a second side different from the first side of the housing detecting a second touch event so as to generate a second sensing signal, and a control unit generating a corresponding operation instruction to control a display object according to the first sensing signal and the second sensing signal simultaneously.

According to the claimed invention, a touch control device with multi-touch function includes a housing including a first side and a second side different from the first side, and a touch control component disposed on the housing. The touch control component includes a first touch sensing unit installed on the first side of the housing for detecting a first touch event so as to generate a first sensing signal according to the first touch event, and a second touch sensing unit installed on the second side of the housing for detecting a second touch event so as to generate a second sensing signal according to the second touch event. The touch control device further includes a control unit coupled to the touch control component, for generating a corresponding operation instruction to control a display object according to the first sensing signal and the second sensing signal simultaneously.

In summary, the touch control device and the related touch control method utilize the different touch events detected by the plurality of touch sensing units installed on different sides of the housing to make corresponding operation instructions, so that the multi-touch control function can be applied more widely. Furthermore, the user does not need to use one hand to hold the touch control device and use the other hand to perform touch control motion. Instead, the user can only use different fingers of one hand to control the touch sensing units on different sides with the same one hand holding the touch control device. As a result, the present invention can achieve multi-touch function with a single hand so as to meet the requirement of various user interfaces and ergonomics of touch control with gestures made by one single hand.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic drawing of a touch control device according to an embodiment of the present invention.

FIG. 2 is a functional block diagram of the touch control device according to the embodiment of the present invention.

FIG. 3 is a flow chart of the touch control device performing the touch control operation according to the embodiment of the present invention.

FIG. 4 to FIG. 8 are diagrams respectively illustrating relative positions of touch points of touch events performed on a first touch sensing unit, a second touch sensing unit and a third touch sensing unit.

FIG. 9 is a diagram illustrating a non-sensing region disposed between touch sensing units of the present invention.

FIG. 10 to FIG. 12 are diagrams respectively illustrating that a user operates the touch control device to perform different instructions.

### DETAILED DESCRIPTION

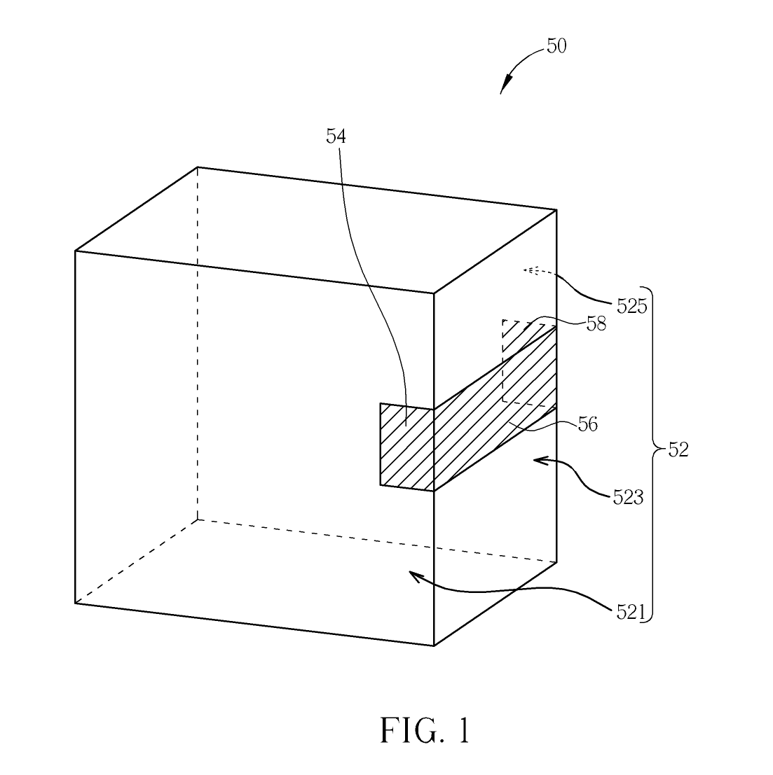

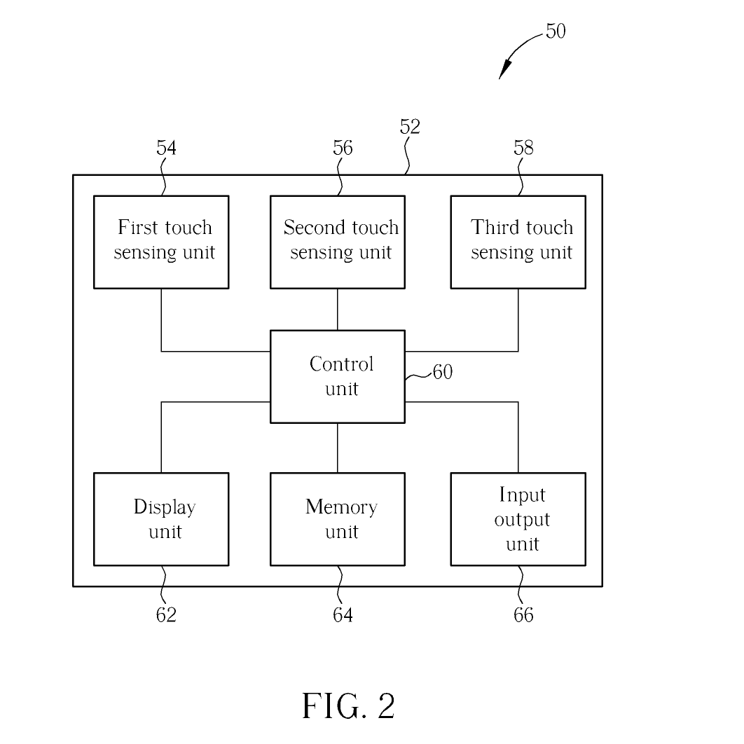

Please refer to FIG. 1 and FIG. 2. FIG. 1 is a schematic drawing of a touch control device 50 according to an embodiment of the present invention. FIG. 2 is a functional block diagram of the touch control device 50 according to the embodiment of the present invention. The touch control device 50 can be a portable electronic device, such as a personal digital assistant, a mobile phone, a PDA phone, and so on. The touch control device 50 includes a housing 52 including a first side 521, a second side 523 and a third side 525. The first side 521 is opposite to the third side 525, and the second side 523 connects the first side 521 and the third side 525. The touch control device 50 further includes a first touch sensing unit 54, a second touch sensing unit 56 and a third touch sensing unit 58. The first touch sensing unit 54 is installed on the first side 521 of the housing 52 for detecting a first touch event so as to generate a first sensing signal according to the first touch event. The second touch sensing unit 56 is installed on the second side 523 of the housing 52 for detecting a second touch event so as to generate a second sensing signal according to the second touch event. The third touch sensing unit 58 is installed on the third side 525 of the housing 52 for detecting a third touch event so as to generate a third sensing signal according to the third touch event. The first touch sensing unit 54, the second touch sensing unit 56 and the third touch sensing unit 58 can be any kinds of touch sensing units, such as a capacitive touch panel, a resistance touch panel, an ultrasonic touch panel, or an infrared touch panel. The first touch sensing unit 54, the second touch sensing unit 56 and the third touch sensing unit 58 can be three regions formed by a bent touch control component. For example, the touch control component can be bent into a U-shaped structure by thermoforming or other types of molding. In other words, the first touch sensing unit 54, the second touch sensing unit 56 and the third touch sensing unit 58 can be three regions of the one touch control component. Alternatively, the first touch sensing unit 54, the second touch sensing unit 56 and the third touch sensing unit 58 can respectively be a touch control component. In other words, the above-mentioned three touch sensing units can be three separate touch control components, and it depends on design demand.

The touch control device 50 further includes a control unit 60 coupled to the first touch sensing unit 54, the second touch sensing unit 56 and the third touch sensing unit 58, for generating a corresponding operation instruction to control the touch control device 50 according to the first sensing signal, the second sensing signal and the third sensing signal simultaneously. The operation instruction is used for controlling a display object. The operation instruction of the display object, for example, can be a motion, a click, a selection or a data input of the display object. The motion, for example, can include sliding, deleting, touching, rotating, deforming, zooming-in or zooming-out, and the click can include a multi-click, a short click or a long click. The control unit 60 can be performed as hardware, software or firmware. For example, the control unit 60 can include a controller and a processor. The controller is used for controlling the first touch sensing unit 54, the second touch sensing unit 56 and the third touch sensing unit 58 and receiving the first touch sensing signal, the second sensing signal and the third sensing signal from the first touch sensing unit 54, the second touch sensing unit 56 and the third touch sensing unit 58. The processor is used for determining a corresponding operation mode according to the related information (e.g. coordinate information or voltage information) of the first touch sensing signal, the second touch sensing signal and the third touch sensing signal and for performing the corresponding operation mode. The touch control device 50 can further include a display unit 62 installed on the housing 52 and coupled to the control unit 60 for displaying a corresponding image information of the operation function. The touch control device 50 can further include a memory unit 64 installed inside the housing 52 and coupled to the control unit 60 for storing data and related programming codes of the touch function. The touch control device 50 can further include an input output unit 66 coupled to the control unit 60 for transmitting data with an external device in a wired or wireless manner.

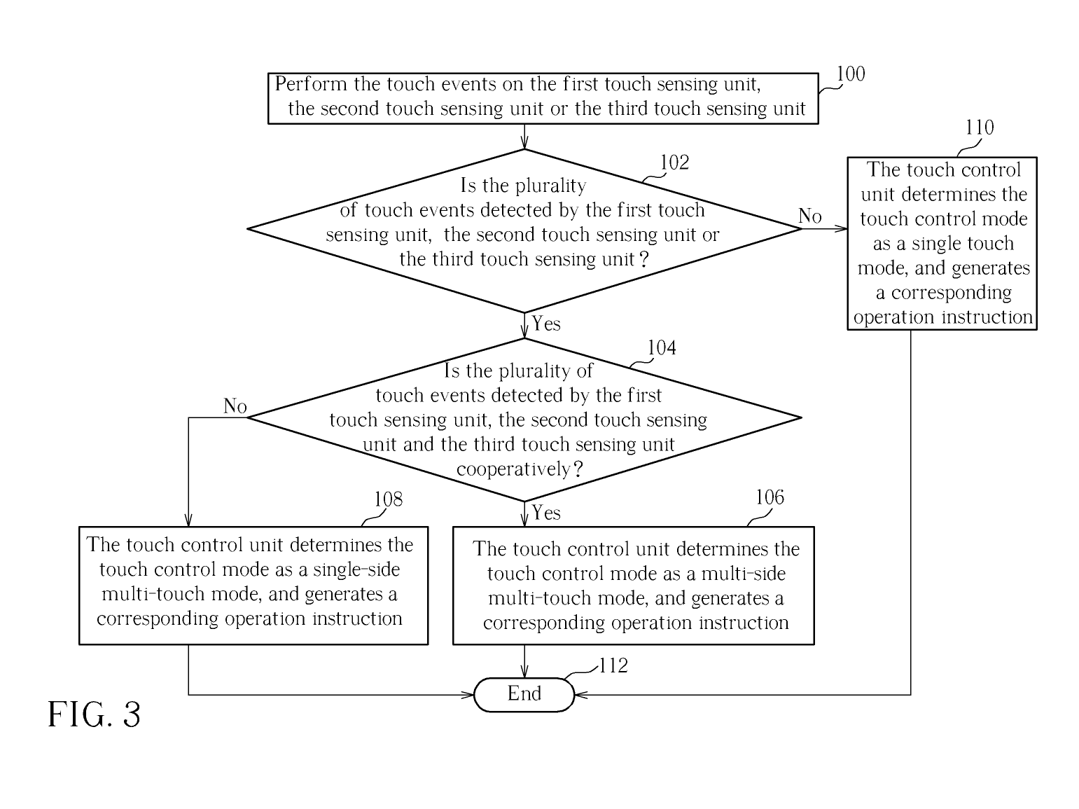

Please refer to FIG. 3. FIG. 3 is a flowchart illustrating the touch control device 50 performing the touch control operation according to the embodiment of the present invention. The related touch control operation includes the following steps:

Step 100: Perform the touch events on the first touch sensing unit 54, the second touch sensing unit 56 or the third touch sensing unit 58.

Step 102: The control unit 60 determines whether the plurality of touch events is detected by the first touch sensing unit 54, the second touch sensing unit 56 or the third touch sensing unit 58. If yes, go to Step 104; if no, go to Step 110.

Step 104: The control unit 60 determines whether the plurality of touch events is detected by the first touch sensing unit 54, the second touch sensing unit 56 and the third touch sensing unit 58 cooperatively. If yes, go to Step 106; if no, go to Step 108.

Step 106: The touch control unit 60 determines the touch control mode as a multi-side multi-touch mode, and generates a corresponding operation instruction according to the plurality of touch sensing signals corresponding to the plurality of touch events generated by the first touch sensing unit 54, the second touch sensing unit 56 and the third touch sensing unit 58.

Step 108: The touch control unit 60 determines the touch control mode as a single-side multi-touch mode, and generates a corresponding operation instruction according to the plurality of touch sensing signals corresponding to the plurality of touch events generated by one of the first touch sensing unit 54, the second touch sensing unit 56 or the third touch sensing unit 58.

Step 110: The touch control unit 60 determines the touch control mode as a single touch mode, and generates a corresponding operation instruction according to the one touch sensing signal corresponding to the one touch event generated by one of the first touch sensing unit 54, the second touch sensing unit 56 or the third touch sensing unit 58.

Step 112: End.

More detailed description for the above-mentioned flowchart is provided as follows. First, the touch events are performed on the first touch sensing unit 54, the second touch sensing unit 56 or the third touch sensing unit 58. The touch events can relate to a motion, a click, a selection, a data input and so on. For example, the motion can include sliding, deleting, touching, rotating, deforming, zooming-in or zooming-out, and the click can include a multi-click, a short click or a long click. In other words, performing the touch events on the first touch sensing unit 54, the second touch sensing unit 56 or the third touch sensing unit 58 can be achieved by the gesture or the plural fingers. Next, the control unit 60 determines whether the plurality of touch events is detected by the first touch sensing unit 54, the second touch sensing unit 56 or the third touch sensing unit 58. That is, the control unit 60 determines the above-mentioned touch events to be the multi-touch mode or the single touch mode. If the above-mentioned touch events are determined to be the multi-touch mode, the control unit 60 continues to determine whether the plurality of touch events is detected by the first touch sensing unit 54, the second touch sensing unit 56 and the third touch sensing unit 58 cooperatively. That is, the control unit 60 determines the multi-touch mode to be the multi-side multi-touch mode or the single-side multi-touch mode.

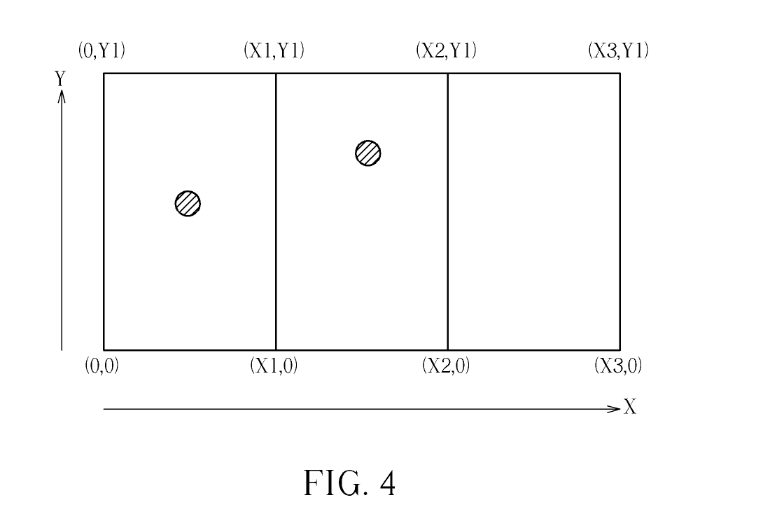

Please refer to FIG. 4 to FIG. 8. FIG. 4 to FIG. 8 are diagrams respectively illustrating relative positions of touch points of the touch events performed on the first touch sensing unit 54, the second touch sensing unit 56 and the third touch sensing unit 58. Take the first touch sensing unit 54, the second touch sensing unit 56 and the third touch sensing unit 58 being three regions of the one touch control component for example, FIG. 4 to FIG. 8 illustrates the relative positions of the touch points of the different touch events on the first touch sensing unit 54, the second touch sensing unit 56 and the third touch sensing unit 58 which are in expanded state. The touch point being located in a range of coordinate within (0,0) to (X1, Y1) corresponds to the touch event on the first touch sensing unit 54. The touch point being located in a range of coordinate within (X1,0) to (X2, Y1) corresponds to the touch event on the second touch sensing unit 56. The touch point being located in a range of coordinate within (X2,0) to (X3, Y1) corresponds to the touch event on the third touch sensing unit 58.

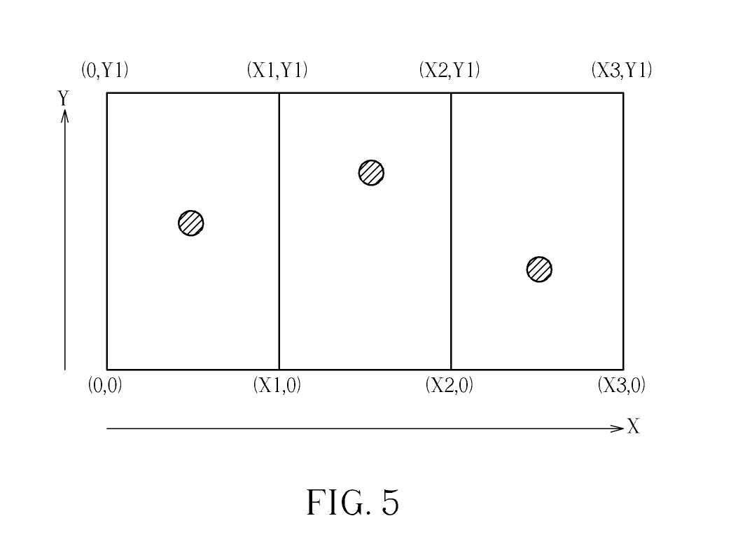

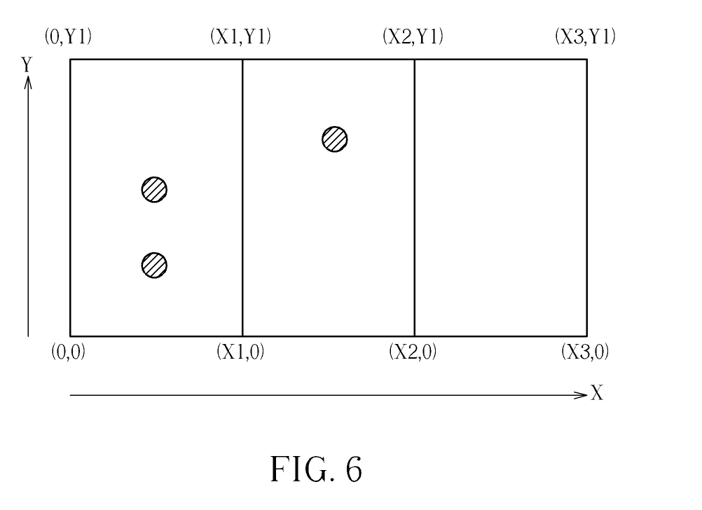

For example, as shown in FIG. 4, when the first touch sensing unit 54 and the second touch sensing unit 56 respectively detects the first touch event and the second touch event performed thereon, the first touch sensing unit 54 and the second touch sensing unit 56 can generate the first sensing signal and the second sensing signal according to the first touch event and the second touch event, respectively. After the control unit 60 receives the first sensing signal and the second sensing signal, the control unit 60 can determine that the first sensing signal and the second sensing signal belong to different touch events on the touch sensing units according to the related information (e.g. coordinate information or voltage information) of the first sensing signal and the second sensing signal. That is, it is the multi-side multi-touch mode. Accordingly, the control unit 60 can generate the corresponding operation instruction to control the touch control device 50 to perform the corresponding operation. Similarly, as shown in FIG. 5, when the first touch sensing unit 54, the second touch sensing unit 56 and the third touch sensing unit 58 respectively detects the first touch event, the second touch event and the third touch event performed thereon, the first touch sensing unit 54, the second touch sensing unit 56 and the third touch sensing unit 58 can generate the first sensing signal, the second sensing signal and the third sensing signal according to the first touch event, the second touch event and the third touch event respectively. It is also the multi-side multi-touch mode. As shown in FIG. 6, main difference between FIG. 4 and FIG. 6 is that the first touch sensing unit 54 can detect the first touch event and a fourth touch event simultaneously and generates a fourth touch sensing signal according to the fourth touch event. Accordingly, the first touch sensing unit 54 and the second touch sensing unit 56 can generate the first sensing signal, the fourth sensing signal and the third sensing signal according to the first touch event, the fourth touch event and the third touch event respectively. It is also the multi-side multi-touch mode. In summary, as long as the touch sensing units on multiple sides detect the plurality of touch events simultaneously, it belongs to the multi-side multi-touch mode.

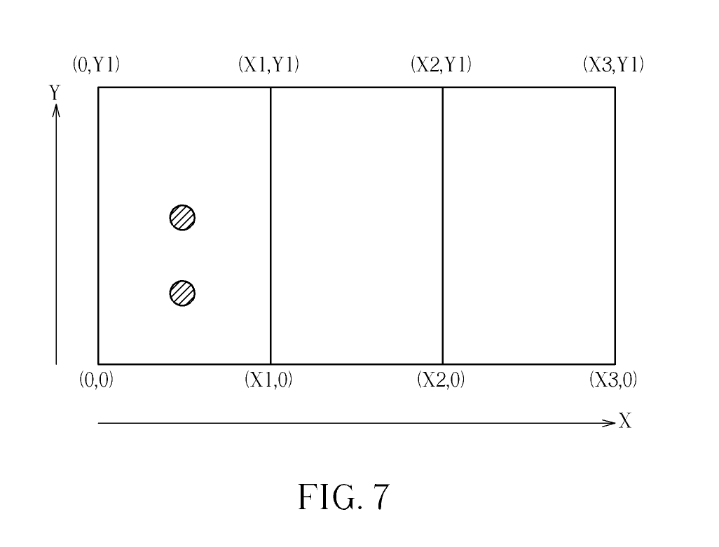

As shown in FIG. 7, only the first touch sensing unit 54 detects the first touch event and the fourth touch event simultaneously, and the other touch sensing units do not detect the corresponding touch event. In this case, it is the single-side multi-touch mode. Accordingly, the control unit 60 can generate the corresponding operation instruction to control the touch control device 50 to perform the corresponding operation. In summary, as long as the touch sensing unit on one single side detects the plurality of touch events simultaneously, it belongs to the single-side multi-touch mode.

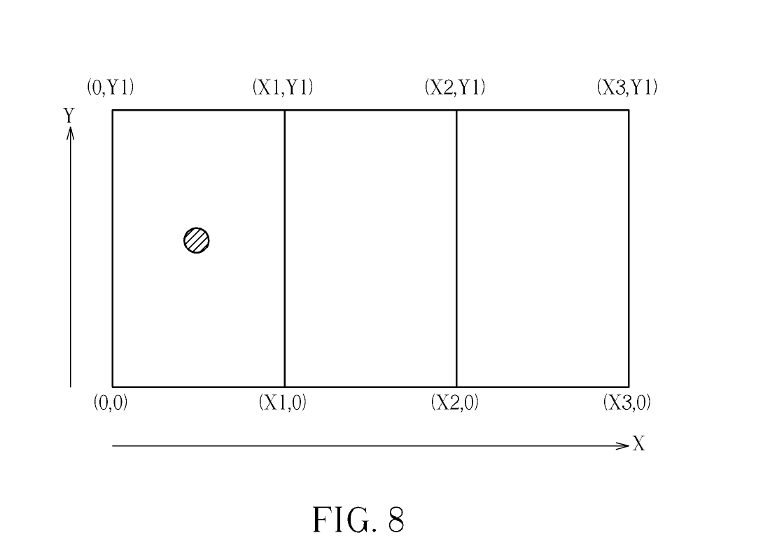

If the control unit 60 detects the first touch sensing unit 54, the second touch sensing unit 56 or the third touch sensing unit 58 detects only one touch event. That is, one of the first touch sensing unit 54, the second touch sensing unit 56 or the third touch sensing unit 58 can only generate the single sensing signal according to the single touch event. Accordingly, the control unit 60 determines the touch control mode to be the single touch mode. As shown in FIG. 8, when only the first touch sensing unit 54 detects the first touch event performed thereon, the first touch sensing unit 54 generates the first sensing signal according to the first touch event. Accordingly, the control unit 60 can determine the touch control mode to be the single touch mode after receiving the single first sensing signal, so as to generate the corresponding operation instruction to control the touch control device 50 to perform the corresponding operation. In summary, as long as the touch sensing unit on one single side detects the single touch event, it belongs to the single touch mode.

Furthermore, the present invention is not limited to the above-mentioned disposition of structure. For example, the touch control device of the present invention can be equipped with only two touch sensing units disposed either on the two opposite sides or on the two adjacent sides of the housing 52. The two touch sensing units can be two sensing regions of one touch control component (e.g. a touch panel, a touch control sensor, a touch control key switch and so on). If the tow touch sensing units are installed on two non-adjacent sides of the housing 52, the sensing region therebetween, such as the second touch sensing unit 56 between the first touch sensing unit 54 and the third touch sensing unit 58 in the above-mentioned embodiment, can be masked by structural components, or alternatively the sensing region therebetween can be deactivated by software. In other words, another characteristic of the present invention is that each touch sensing unit can be different sensing regions of the same one touch control component and be formed on different sides of the housing 52. On the other hand, two or more than two touch sensing units can probably be separate touch components, that is, they can be components separate from each other. The touch control device of the present invention can also be equipped with four touch sensing units disposed on the four surrounding sides of the housing 52, and it depends on design demand.

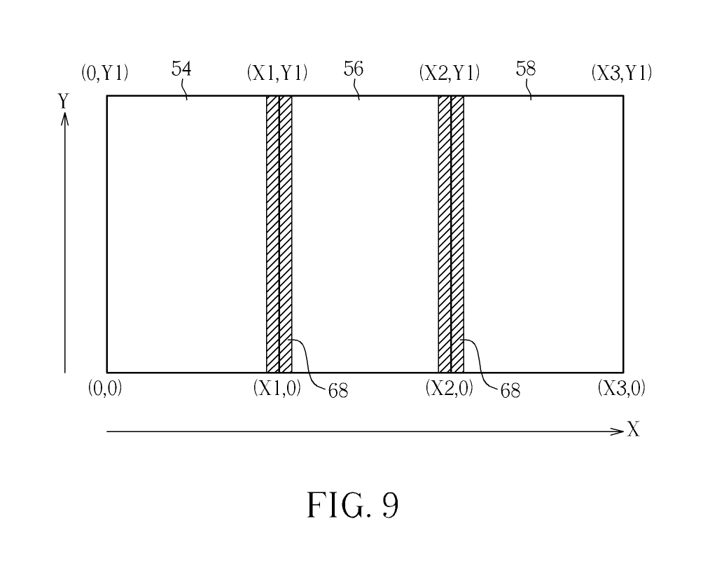

Moreover, if the first touch sensing unit 54, the second touch sensing unit 56 and the third touch sensing unit 58 are three regions formed by a bent touch control component, non-sensing regions can be disposed between the first touch sensing unit 54 and the second touch sensing unit 56 and between the second touch sensing unit 56 and the third touch sensing unit 58 for avoiding an abnormal determination at positions where the touch sensing units are bent. In other words, it is an invalid region. Please refer to FIG. 9. FIG. 9 is a diagram illustrating a non-sensing region 68 disposed between touch sensing units of the present invention. An insulated layer can be disposed on the non-sensing region 68 between the first touch sensing unit 54 and the second touch sensing unit 56 and between the second touch sensing unit 56 and the third touch sensing unit 58, or alternatively the non-sensing region 68 can be deactivated by software. It depends on design demand.

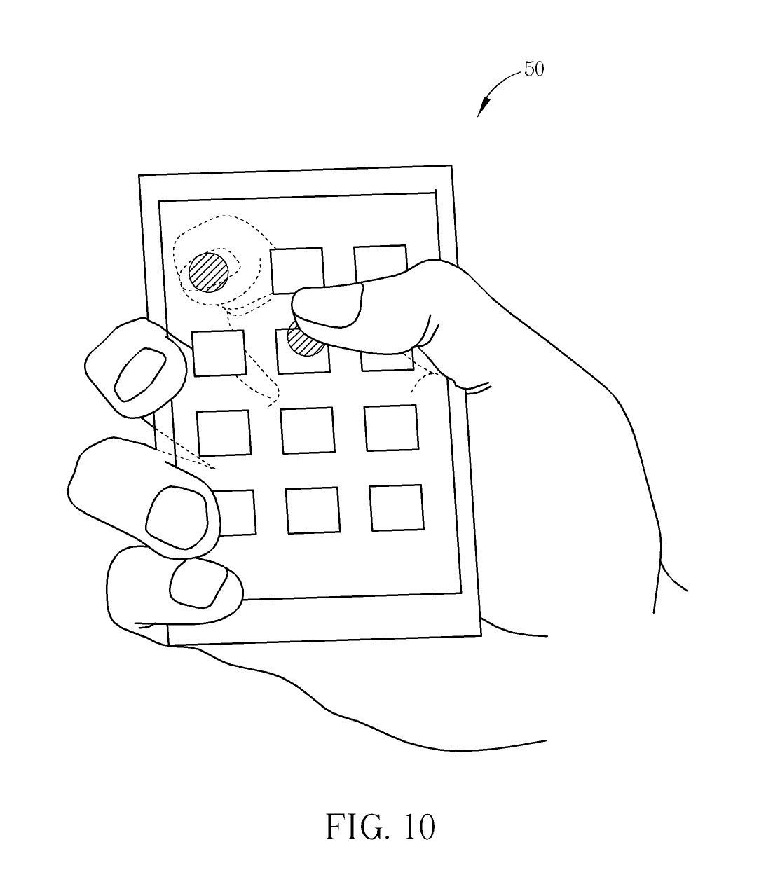

As known above, the touch events detected by the plurality of touch sensing regions disposed on the different sides of the housing 52 of the touch control device 50 can constitute a variety of corresponding operation instructions. For example, please refer to FIG. 10 to FIG. 12. FIG. 10 to FIG. 12 are diagrams respectively illustrating a user operates the touch control device 50 to perform different instructions. As shown in FIG. 10, the touch control device 50 can be designed as the first touch event, generated from the first touch sensing unit 54 on the front side when a finger of the user touches thereon, represents selecting a corresponding icon, and simultaneously the third touch event, generated from the third touch sensing unit 58 on the rear side when another finger of the user touches thereon, represents performing function of the corresponding icon selected from the first touch event. In other words, the user can operate the touch control device 50 with one hand, utilizing one finger (e.g. a thumb) to select the icon to be executed and utilizing another finger (e.g. a forefinger) to perform the selected icon by clicking, so as to achieve ergonomics of touch control with gestures made by one single hand.

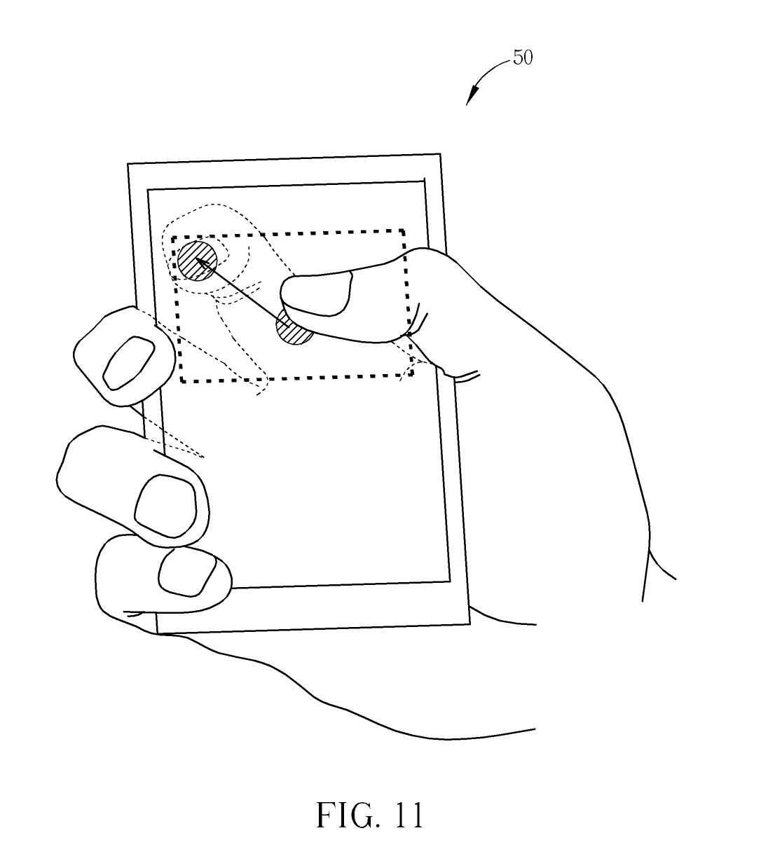

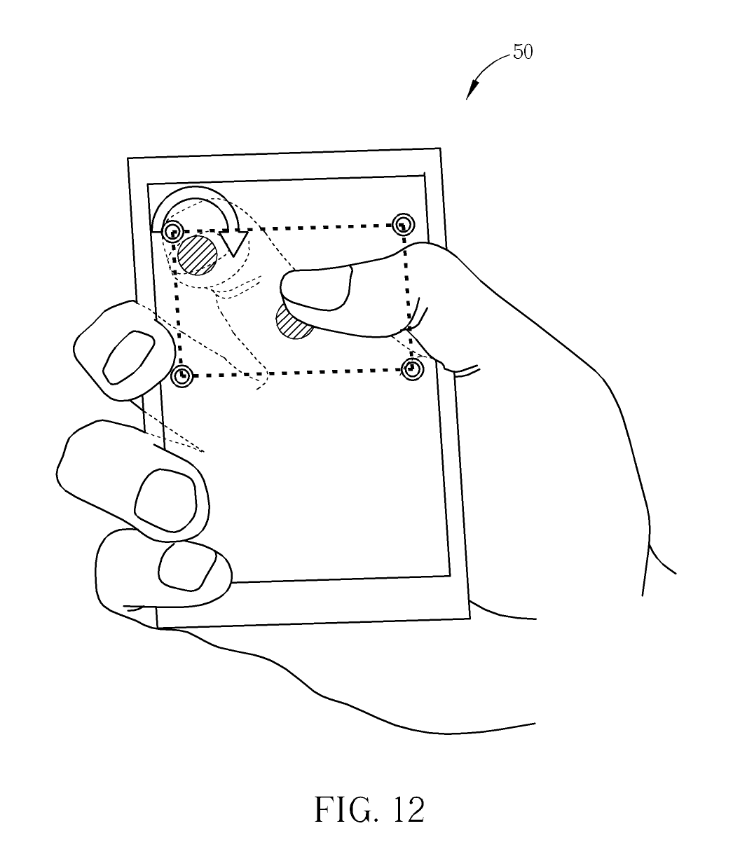

Moreover, as shown in FIG. 11 and FIG. 12, the touch control device 50 can be alternatively designed as the first touch event, generated from the first touch sensing unit 54 on the front side when a finger of the user touches thereon, represents selecting a central point of a corresponding picture, and simultaneously the third touch event, generated from the third touch sensing unit 58 on the rear side when another finger of the user touches thereon, represents performing function of the corresponding picture selected from the first touch event. As illustrated in FIG. 11, the user can operate the touch control device 50 with one hand, utilizing one finger to select the picture to be operated and utilizing another finger to zoom-in or zoom-out the selected picture by sliding, so as to achieve ergonomics of touch control with gestures made by one single hand. As illustrated in FIG. 12, the user can operate the touch control device 50 with one hand, utilizing one finger to select the picture to be operated and utilizing another finger to rotate the selected picture by rotation, so as to achieve ergonomics of touch control with gestures made by one single hand. As know above, the present invention can include different control instructions by the different touch events detected by the plurality of touch sensing units, such as selection with performing, selection with operation, selection with data input and so on. Any method for utilizing the plurality of touch sensing units to detect different touch events so as to generate the corresponding operation instructions is all within the scope of the present invention.

Compared with the prior art, the touch control device and the related touch control method utilize the different touch events detected by the plurality of touch sensing units installed on different sides of the housing to make corresponding operation instructions, so that the multi-touch control function can be applied more widely, wherein each of the touch sensing units can be different sensing regions of the same one touch control component, or be the separate touch control components. Furthermore, the user does not need to use one hand to hold the touch control device and use the other hand to perform touch control motion. Instead, the user can only use different fingers of one hand to control the touch sensing units on different sides with the same one hand holding the touch control device. As a result, the present invention can achieve multi-touch function with a single hand so as to meet the requirement of various user interfaces and ergonomics of touch control with gestures made by one single hand.

Those skilled in the art will readily observe that numerous modifications and alterations of the device and method may be made while retaining the teachings of the invention.

What is claimed is:

1. A touch control device with multi-touch function, comprising:
a housing comprising a first side and a second side different from the first side;
a first touch sensing unit installed on the first side of the housing for detecting a first touch event so as to generate a first sensing signal according to the first touch event;
a second touch sensing unit installed on the second side of the housing for detecting a second touch event so as to generate a second sensing signal according to the second touch event; and
a control unit coupled to the first touch sensing unit and the second touch sensing unit, for generating a corresponding operation instruction to control a display object according to the first sensing signal and the second sensing signal simultaneously.

2. The touch control device of claim 1, wherein the first touch sensing unit and the second touch sensing unit are two regions of a touch control component, and the control unit is used for determining whether the first sensing signal or the second sensing signal is generated by the first touch sensing unit or the second touch sensing unit according to related information of the first sensing signal or the second sensing signal.

3. The touch control device of claim 2, wherein the control unit is used for determining whether the first sensing signal or the second sensing signal is generated by the first touch sensing unit or the second touch sensing unit according to the related coordinate information of the first sensing signal or the second sensing signal.

4. The touch control device of claim 2, wherein the control unit is used for determining whether the first sensing signal or the second sensing signal is generated by the first touch sensing unit or the second touch sensing unit according to the related voltage information of the first sensing signal or the second sensing signal.

5. The touch control device of claim 2, wherein a non-sensing region is disposed between the first touch sensing unit and the second touch sensing unit.

6. The touch control device of claim 5, wherein the non-sensing region is an insulated layer.

7. The touch control device of claim 1, wherein the first touch sensing unit and the second touch sensing unit are two separate touch control components.

8. The touch control device of claim 1, wherein the first touch sensing unit and the second touch sensing unit are two regions formed by a bent touch control component.

9. The touch control device of claim 1, wherein the first side and the second side are two adjacent sides of the housing.

10. The touch control device of claim 1, wherein the housing further comprises a third side, the first side and the third side are two opposite sides of the housing, the second side connects the first side and the third side, the touch control device further comprises a third touch sensing unit installed on the third side of the housing for detecting a third touch event so as to generate a third sensing signal according to the third touch event, the control unit is further coupled to the third touch sensing unit for generating a corresponding operation instruction according to the first sensing signal, the second sensing signal and the third sensing signal simultaneously.

11. The touch control device of claim 10, wherein the first touch sensing unit, the second touch sensing unit and the third touch sensing unit are three regions formed by a bent touch control component.

12. The touch control device of claim 1, wherein the first touch sensing unit is used for detecting a fourth touch event simultaneously as detecting the first touch event so as to generate a fourth sensing signal according to the fourth touch event, and the control unit is further used for generating a corresponding operation instruction according to the first sensing signal and the fourth sensing signal simultaneously.

13. The touch control device of claim 1, wherein the operation instruction is associated with a motion, a click, a selection or a data input of the display object.

14. The touch control device of claim 13, wherein the motion comprises sliding, deleting, touching, rotating, deforming, zooming-in or zooming-out.

15. The touch control device of claim 13, wherein the click comprises a multi-click, a short click or a long click.

16. A touch control method for multi-touch function, comprising:
a first touch sensing unit installed on a first side of a housing detecting a first touch event so as to generate a first sensing signal;
a second touch sensing unit installed on a second side different from the first side of the housing detecting a second touch event so as to generate a second sensing signal; and
a control unit generating a corresponding operation instruction to control a display object according to the first sensing signal and the second sensing signal simultaneously.

17. The touch control method of claim 16, further comprising:
the control unit determining whether the first sensing signal or the second sensing signal is generated by the first touch sensing unit or the second touch sensing unit according to related information of the first sensing signal or the second sensing signal.

18. The touch control method of claim 17, wherein the control unit determines whether the first sensing signal or the second sensing signal is generated by the first touch sensing unit or the second touch sensing unit according to the related coordinate information of the first sensing signal or the second sensing signal.

19. The touch control method of claim 17, wherein the control unit determines whether the first sensing signal or the second sensing signal is generated by the first touch sensing unit or the second touch sensing unit according to the related voltage information of the first sensing signal or the second sensing signal.

20. The touch control method of claim 16, further comprising:
the first touch sensing unit detecting a fourth touch event simultaneously as detecting the first touch event so as to generate a fourth sensing signal, and the control unit generating a corresponding operation instruction according to the first sensing signal and the fourth sensing signal simultaneously.

21. The touch control method of claim 16, further comprising:
the control unit determining whether the plurality of touch events is detected by the first touch sensing unit or the second touch sensing unit.

22. The touch control method of claim 21, further comprising:
the control unit determining whether the plurality of touch events is detected by the first touch sensing unit together with the second touch sensing unit after the plurality of touch events is detected by the first touch sensing unit or the second touch sensing unit.

23. The touch control method of claim 16, wherein the operation instruction is associated with to a motion, a click, a selection or a data input of the display object.

24. A touch control device with multi-touch function, comprising:
a housing comprising a first side and a second side different from the first side;
a touch control component disposed on the housing, the touch control component comprising:
a first touch sensing unit installed on the first side of the housing for detecting a first touch event so as to generate a first sensing signal according to the first touch event;
a second touch sensing unit installed on the second side of the housing for detecting a second touch event so as to generate a second sensing signal according to the second touch event; and
a control unit coupled to the touch control component, for generating a corresponding operation instruction to control a display object according to the first sensing signal and the second sensing signal simultaneously.
